(19) United States
(12) Patent Application Publication
(10) Pub. No.: US 2026/0050334 A1
(43) Pub. Date: Feb. 19, 2026

(54) TOUCHPAD DEVICE AND METHOD FOR GENERATING TOUCHPAD INFORMATION

(71) Applicant: PIXART IMAGING INC., HSIN-CHU (TW)

(72) Inventor: TSE-CHUNG SU, HSIN-CHU (TW)

(21) Appl. No.: 18/932,833

(22) Filed: Oct. 31, 2024

Related U.S. Application Data
(60) Provisional application No. 63/683,709, filed on Aug. 16, 2024.

(51) Int. Cl. G06F 3/0354; G06F 3/038

(52) U.S. Cl. CPC G06F 3/03547; G06F 3/038

(57) ABSTRACT

A touchpad and a method for generating touchpad information are provided. The method includes: performing by a controller: in response to detecting that a first touch object is located in a sensing region of the touchpad, determining whether or not a specific touch event is identified; in response to determining that the specific touch event is identified, determining whether a second touch object is located in a first predefined region of the sensing region, and determining whether the second touch object is a predefined object; in response to determining that the second touch object is located in the first predefined region and the second touch object is the predefined object, reporting first touch information and second touch information to an operation system. The first touch information indicates that the second touch object leaves the sensing region, and the second touch information indicates that the specific touch event occurs.

### CROSS-REFERENCE TO RELATED PATENT APPLICATION

This application claims the benefit of priority to the U.S. Provisional Patent Application Ser. No. 63/683,709, filed on Aug. 16, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a device and a method, and more particularly to a touchpad device and a method for generating touchpad information.

### BACKGROUND OF THE DISCLOSURE

In the related art, a trackpad is designed with a single physical button. However, in the case of a precision touchpad (PTP), the interpretation of a left or right button press is not solely dependent on this physical button. Instead, it involves a more complex process that takes into account both pressing information and the position of the finger on the trackpad. This comprehensive consideration of both the physical button pressing and the finger's position allows the PTP to emulate the functionality of a traditional mouse.

However, there can be instances of unintended inputs. For example, when a user wants to input a “click” event and press the lower left corner of the trackpad by the user's finger to generate a left-click command, if the user's palm is resting on the lower right corner of the touchpad at the same time, the touchpad might mistakenly interpret that the user is inputting a “right-click” command. So, the PTP might incorrectly generate a “right-click” command. This could lead to an undesired action, as the user did not intend to perform a right-click operation.

Moreover, this false detection can also interfere with other touchpad operations. For example, if the system mistakenly identifies a resting palm as a finger press, it might ignore actual finger sliding operations on the touchpad. This could potentially disrupt the user's interaction with the device, as the touchpad might not respond correctly to the user's intended actions.

### SUMMARY OF THE DISCLOSURE

In response to the above-referenced technical inadequacies, the present disclosure provides a touchpad device and a method for generating touchpad information.

In order to solve the above-mentioned problems, one of the technical aspects adopted by the present disclosure is to provide a method for generating touchpad information, and the method includes: performing, by a controller connected to a touchpad, following processes: in response to detecting that a first touch object is located in a sensing region of the touchpad, determining whether or not a specific touch event is identified; in response to determining that the specific touch event is identified, determining whether a second touch object is located in a first predefined region of the sensing region, and determining whether the second touch object is a predefined object; in response to determining that the second touch object is located in the first predefined region and the second touch object is the predefined object, reporting first touch information and second touch information to an operation system. The first touch information indicates that the second touch object leaves the sensing region, and the second touch information indicates that the specific touch event occurs.

In order to solve the above-mentioned problems, another one of the technical aspects adopted by the present disclosure is to provide a method for generating touchpad information, and the method includes: performing, by a controller connected to a touchpad, following processes: in response to detecting a first touch object and a second touch object are located in a sensing region of the touchpad, determining whether the first touch object and the second touch object are respectively a finger object and a non-finger object simultaneously appearing in the sensing region; in response to determining that the first touch object and the second touch object are the finger object and the non-finger object simultaneously appearing in the sensing region, reporting first touch information to an operation system indicating that the first touch object contacts the sensing region to an operation system and not reporting to the operation system that the second touch object contacts the sensing region.

In order to solve the above-mentioned problems, yet another one of the technical aspects adopted by the present disclosure is to provide a method for generating touchpad information, and the method includes: performing, by a controller connected to a touchpad, following processes: in response to detecting a first touch object and a second touch object are located in a sensing region of the touchpad, determining whether the first touch object and the second touch object are non-finger objects; in response to detecting that the first touch object and the second touch object are non-finger objects, reporting first touch information to an operation system that the first touch object contacts the sensing region and not reporting to an operation system that the second object contacts the sensing region.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a touchpad device according to one embodiment of the present disclosure;

FIG. 2 is a flowchart of a method for generating touchpad information according to one embodiment of the present disclosure;

FIG. 3 is a schematic view of a sensing region with detected objects in a first scenario according to one embodiment of the present disclosure;

FIG. 4 is a flowchart of processes for determining whether or not a touch object is a palm object according to one embodiment of the present disclosure;

FIG. 5 is a schematic view of step S112 of the method for generating the touchpad information according to one embodiment of the present disclosure;

FIG. 6 is a schematic view of step S113 of the method for generating the touchpad information according to one embodiment of the present disclosure;

FIG. 7 is a flowchart of a method for generating touchpad information according to another one embodiment of the present disclosure;

FIG. 8 is a schematic view of the sensing region with a detected finger object and a detected non-finger object according to the another one embodiment of the present disclosure;

FIG. 9 is a flowchart of a method for generating touchpad information according to yet another one embodiment of the present disclosure; and

FIG. 10 is a schematic view of the sensing region with two detected non-finger objects according to the another one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

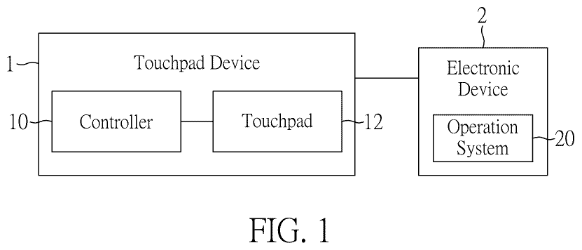

FIG. 1 is a functional block diagram of a touchpad device according to one embodiment of the present disclosure. Referring to FIG. 1, one embodiment of the present disclosure provides a touchpad device 1, which includes a controller 10 and a touchpad 12. The touchpad device 1 is also referred to as a trackpad, can be an input device that is connected to an electronic device 2, such as a laptop or a desktop computer. The touchpad device 1 allows the user to move a cursor with their finger and can be used in place of an external mouse. In general, the touchpad device 1 can be operated using finger and dragging it across a flat surface of the touchpad 12.

The controller 10 is connected to the touchpad 12, and can be a microcontroller that monitors all inputs from the touchpad 12 and interprets them into signals for an operating system 20 that runs on the electric device 2. The controller 10 can operate based on various mechanisms, including capacitive or resistive sensing. For example, in the capacitive sensing mechanism, the change of capacitance where a finger touches the touchpad 12 is sensed.

The touchpad 12 can be a capacitive touchpad, a resistive touchpad, or a haptic touchpad. For the capacitive touchpad, a two-dimensional grid of sensors is typically utilized, each of sensors capable of holding an electrical charge. When a finger approaches the sensor surface, it disturbs the electrical field and changes the capacitance at that sensor.

For the resistive touchpad, several layers are typically included. When the top layer is pressed, it makes contact with the bottom layer, and the coordinates of the touch are determined by measuring the electrical resistance.

For the haptic touchpad, a combination of a touch-sensing component, a force-sensing component, and a haptic actuator is utilized. The touch-sensing component detects the position of the touch, the force-sensing component measures the amount of pressure applied, and the haptic actuator provides tactile feedback.

In some embodiments, the touchpad 12 can be equipped with physical buttons or a pressing mechanism by utilizing the haptic actuator, so as to provide a function similar to the left-click function of a mouse. Furthermore, a switch circuit can be additionally used for the pressing mechanism. When the touchpad 12 is pressed, the switch circuit could be activated to send a press signal to the operating system of the electronic device 2.

It should be noted that the touchpad 12 can be a precision touchpad (PTP), which is designed to work closely with the operating system of the electronic device 2, in which multiple fingers can be detected to enable sophisticated gestures. For example, on the PTP, a user can zoom in or out with two fingers, swipe with three fingers, and tap with four fingers. Therefore, the operating system 20 can support a variety of gestures on the PTP, the gestures can include one-finger tap, two-finger scroll and zoom, three-finger swipe to switch between open applications, and four-finger tap to open a specific management interface.

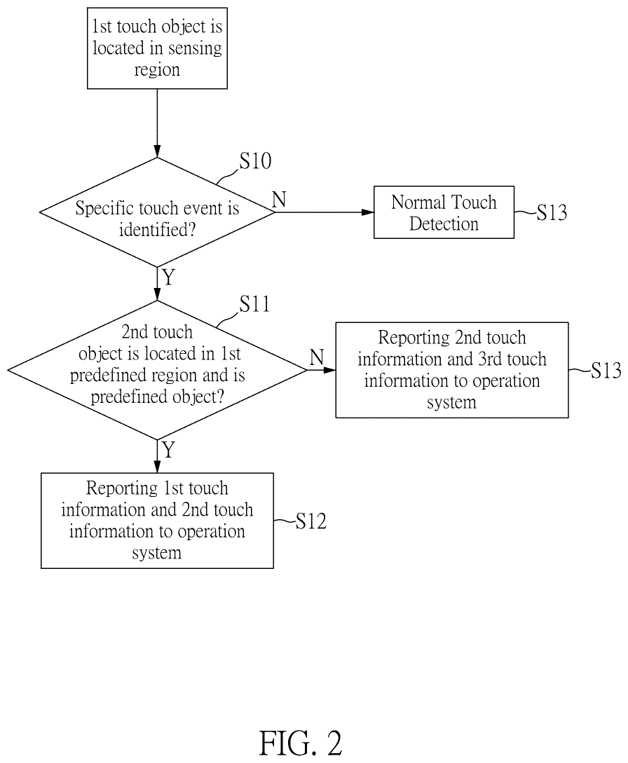

FIG. 2 is a flowchart of a method for generating touchpad information according to one embodiment of the present disclosure. Referring to FIG. 2, the present disclosure provides a method for generating touchpad information, the method is suitable for the touchpad device 1 depicted in FIG. 1, but the present disclosure is not limited thereto. It should be noted that the method provided by the present disclosure is executed under a premise that the controller 10 and the touchpad 12 are powered on and jointly perform the touch detection in advance, therefore the description of this basic operation is omitted.

As shown in FIG. 2, the method can include the following steps that are performed by the controller 10:

Step S10: detecting whether or not a specific touch event is identified in response to detecting a first touch object is located in a sensing region of the touchpad.

In step S10, the specific touch event can be a click event. The controller 10 can be configured to identify the specific touch event by determining whether or not one of a single-tap event, a physical-click event, a tap-to-click event, and a corner-tap event occurs.

More specifically, for the touchpad 12 equipped with physical buttons or the pressing mechanism by utilizing the haptic actuator, the single-tap event can be detected by simply tapping the touchpad 12 with one finger, the physical-click can be detected by pressing down on the touchpad 10 until a click is triggered by the pressing mechanism of the touchpad 10, the tap-to-click event can be detected by the touchpad 12 having enabled the “Tap to Click” feature, so as to allow a single tap to register as a click event. The corner-tap event can be detected by tap a lower-left corner or a lower-right corner of the touchpad 12. In certain embodiments, the click event can also be triggered by pressing the touchpad 12 equipped with a pressure sensor, when a pressure caused by the external force is larger than a predetermined pressure, the click event can be identified.

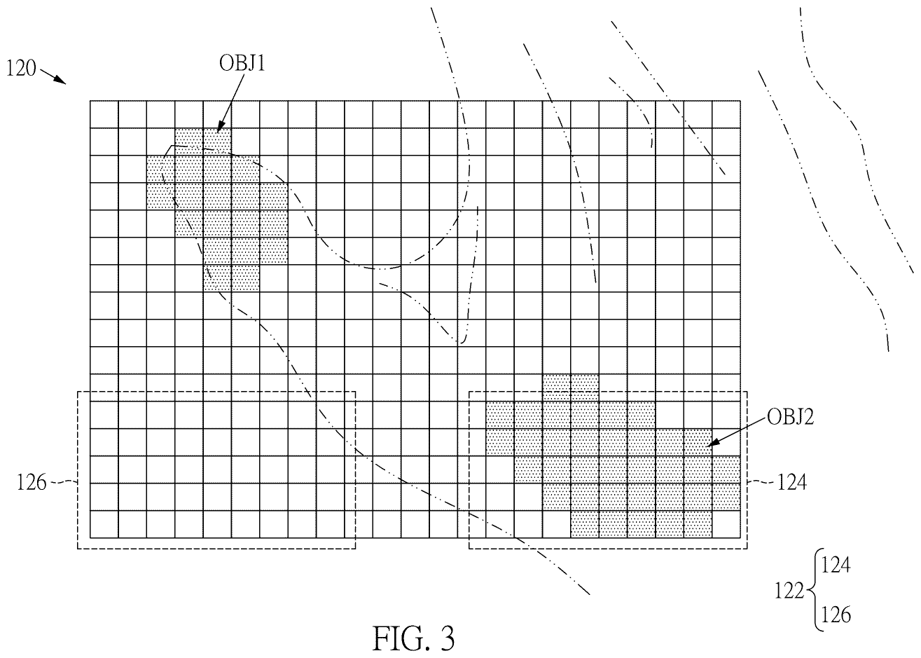

FIG. 3 is a schematic view of a sensing region with detected touch objects in a first scenario according to one embodiment of the present disclosure. Reference is made to FIG. 3. For example, in the first scenario, a user places his/her hand on the touchpad 12 and presses the touchpad 12 with the thumb. The palm of the user may contact a sensing region 120 of the touchpad 12 when the user presses the sensing region 120 with his/her thumb. Therefore, a touch object OBJ1 is detected and a click event can be identified by the touchpad 12.

In response to determining that the specific touch event is identified in step S10, the method proceeds to step S11: determining whether a second touch object is located in a first predefined region of the sensing region, and determining whether the second touch object is a predefined object. Referring to FIG. 3, in step S11, the first predefined region 122 can include a first sub-region 124 located at a lower right corner of the sensing region 120 and a second sub-region 126 located at a lower left corner of the sensing region 120. Here, the predefined object refers to a non-finger object, generally similar to a palm-related object. For example, in Windows® precision touchpad (PTP) specifications, the non-finger objects are marked in confidence bit as 0.

More specifically, when the controller 10 detects that the first touch object OBJ1 is located in the sensing region 120 and identifies the click event, if a second touch object OBJ2 is sensed by the touchpad 12, the controller 10 further determines whether or not the second touch object OBJ2 is located in the first sub-region 124 or a second sub-region 126, and determining whether or not the second touch object is the palm object. A variety of features of a touch object can be used for determining whether or not the touch object is the palm object, such as a position, an area and a size of the touch object.

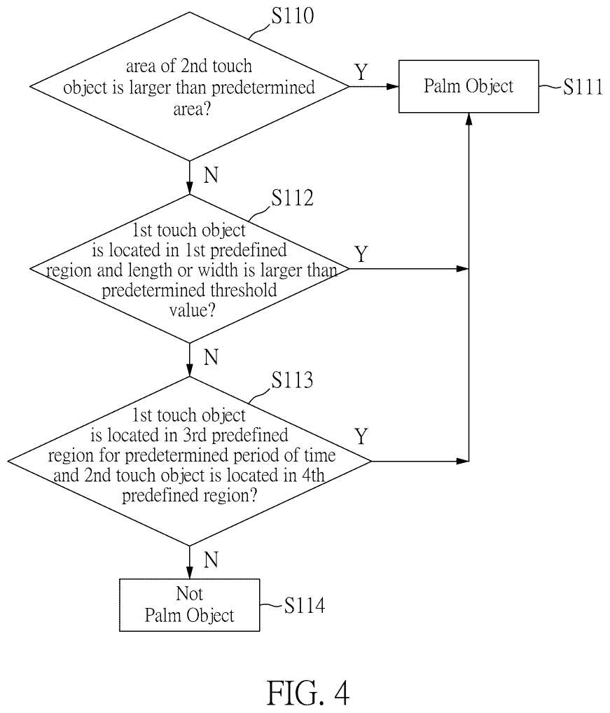

FIG. 4 is a flowchart of processes for determining whether or not a touch object is a palm object according to one embodiment of the present disclosure. Reference is made to FIG. 4, step S11 can further includes the following steps for determining whether the touch object is the palm object:

Step S110: determining whether an area of a touch object is larger than a predetermined area.

In response to determining that the area of the touch object detected by the touchpad is larger than the predetermined area in step S110, the method proceeds to step S111: determining that the first touch object is the palm object.

For example, reference is made to FIG. 3, the predetermined area had an area of 25 sensing pixels, and the area of the touch object OBJ2 sensed by the touchpad 12 has an area of 37 sensing pixels, therefore, the touch object OBJ1 is determined to be the palm object.

Optionally, in response to determining that the area of the first touch object detected by the touchpad is not larger than the predetermined area in step S110, the method proceeds to step S112.

Step S112: determining whether the touch object is located in a second predefined region and a length or a width of the first touch object is larger than a predetermined threshold value.

In response to determining that the first touch object is located in the first predefined region and the length or the width of the first touch object is larger than the predetermined threshold value in step S112, the method proceeds to step S111: determining that the first touch object is the palm object.

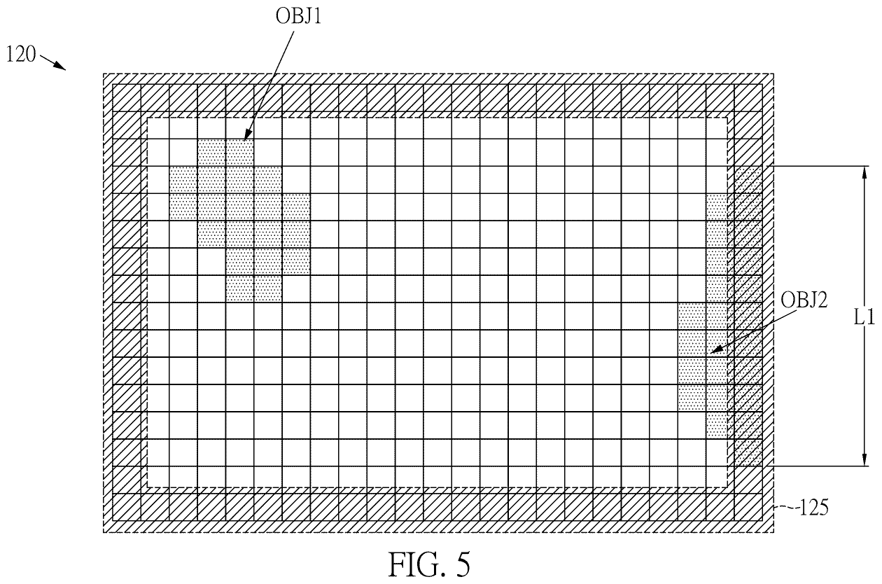

FIG. 5 is a schematic view of step S112 of the method for generating the touchpad information according to one embodiment of the present disclosure. Referring to FIG. 5, the second predefined region 125 can include four edges of the sensing region 120, and the predetermined threshold value can be a total length or a total width of 10 sensing pixels. In the case that the second touch object OBJ2 is detected to be located at one edge of the sensing region 120 and has a length L1 of a total length of 11 sensing pixels, the second touch object OBJ2 is determined to be the palm object.

Optionally, in response to determining that the length or the width of the touch object is not larger than the predetermined threshold value in step S112 in step S110, the method proceeds to step S113.

Step S113: determining whether or not the touch object is located in the first predefined region for a predetermined period of time, an area of another touch object is smaller than a second predetermined area, and the another touch object is located in a third predefined region of the sensing region.

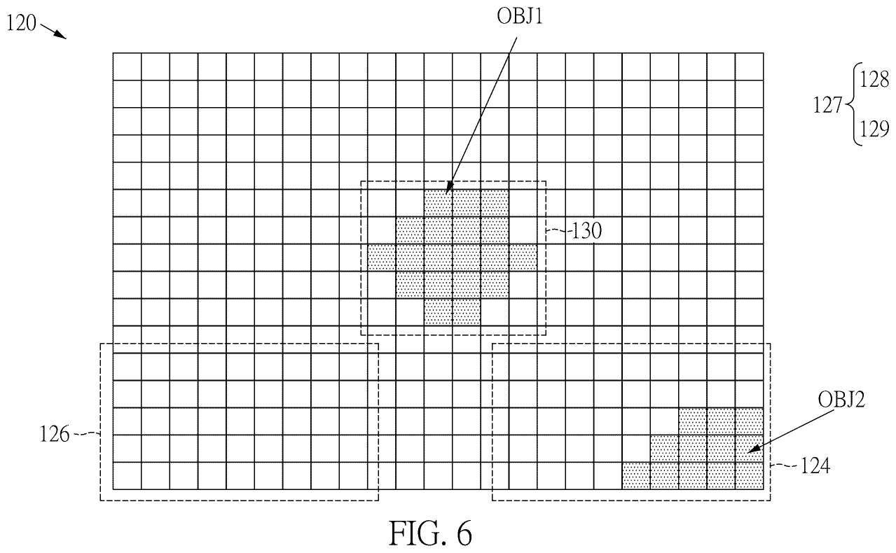

FIG. 6 is a schematic view of step S113 of the method for generating the touchpad information according to one embodiment of the present disclosure. Referring to FIG. 6, the first predefined region 122, as mentioned above, includes the first sub-region 124 and the second sub-region 126, and the third predefined region 130 is located at or near a center of the sensing region 120, and the predetermined period of time can be 0.5 seconds.

In the case of FIG. 6, if the second touch object OBJ2 is detected to be located in the first sub-region 124 for 0.55 seconds, and the first touch object OBJ6 is detected to be located in the third predefined region 130 and has an area smaller than the second predetermined area (e.g., 16 sensing pixels), the second touch object OBJ2 is determined to be the palm object.

In response to determining that the touch object is located in the first predefined region for the predetermined period of time, the area of another touch object is smaller than the second predetermined area, and the another touch object is located in the third predefined region in steps S113, the method proceeds to step S111 to determine that the touch object is the palm object. In response to determining that the touch object is not located in the first predefined region for the predetermined period of time, the area of another touch object is not smaller than the second predetermined area, or the another touch object is not located in the third predefined region in steps S113, the method proceeds to step S114: determining that the touch object is the palm object.

Reference is made to FIG. 2 again. In response to determining that the specific touch event is not identified in step S10, the method repeats step S12: performing a normal touch detection.

For example, if the first touch object is detected without triggering the click event, the controller executes the normal touch detection to report a normal touch information including position information of the first touch object with respect to the sensing region 120.

The normal touch information generated by the normal touch detection is shown in the following table I:

TABLE I

| Touch information | Touch Object | Content |
|---|---|---|
| Normal | 1st | Position: X0/type: finger/left: No |

In some embodiments, the normal touch information can include information such as a serial number, a position, a type and presence status of the detected touch object.

In response to determining that the second touch object OBJ2 is located in the first predefined region 122 and is the predefined object (i.e., the palm object), the method proceeds to step S13: reporting first touch information and second touch information to the operation system. In step S13, the first touch information indicates that the second touch object OBJ2 leaves the sensing region 120, and the second touch information indicates that the specific touch event (e.g., the click event) occurs.

Therefore, the controller 10 can be configured to generate touchpad information that includes the first touch information and the second touch information mentioned in step S13, and the first touch information and the second touch information are shown in the following table II:

TABLE II

| Touch information | Touch Object | Content |
|---|---|---|
| 1st | 1st | Position: X1/type: finger/left: no |
| 2nd | 2nd | Position: X2/type: palm/left: yes |

In some embodiment, the second touch information can be directly reported without the first touch information in step S13, that is, the controller 10 can block the presence of the palm object (the second touch object OBJ2) when the first touch object OBJ1 and the second touch object OBJ2 are simultaneously detected (i.e., two touch objects appears in the sensing region 120 at the same time).

Therefore, when the user wants to perform a left-click action and places his/her finger on the touchpad 12, if his/her palm accidentally touches the sensing region 120, the touchpad device 1 can exclude accidental touch issue and immediately respond the manipulation of the user without any delay or falsely triggering other functions.

In response to determining that the second touch object is detected but not in the first predefined region, or the second touch object is not the predefined object in step S11, the method proceeds to step S13: reporting the second touch information and third touch information to the operating system. The second touch information indicates that the specific touch event occurs, and the third touch information indicates that the second touch object OBJ contacts the sensing region 120.

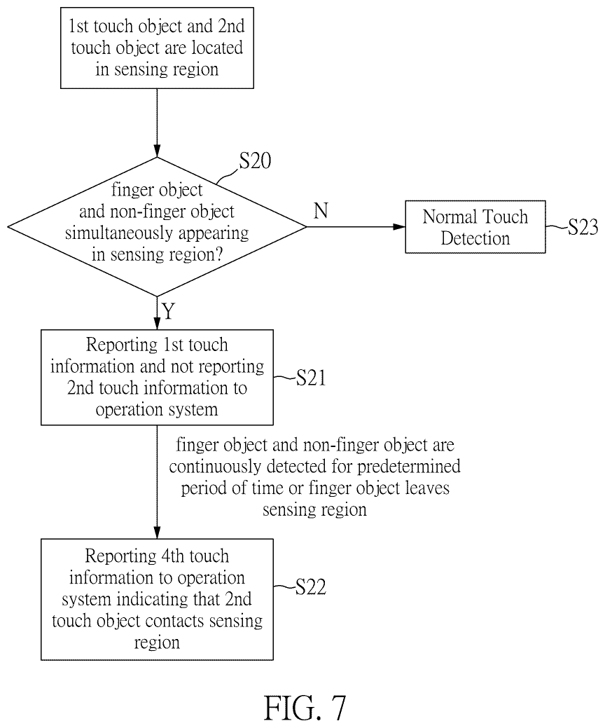

FIG. 7 is a flowchart of a method for generating touchpad information according to another one embodiment of the present disclosure. The present disclosure further provides a method for generating touchpad information, which includes the following steps performed by the controller 10:

Step S20: in response to detecting a first touch object and a second touch object are located in the sensing region of the touchpad, determining whether or not the first touch object and the second touch object are respectively a finger object and a non-finger object simultaneously appearing in the sensing region.

Different from the method of FIG. 2 that the palm object is reported to leave the sensing region 120 according to the click event and the palm object located at a specific position, the method of FIG. 7 uses points in time at which the finger object and the non-finger object (e.g., a palm-related object) appear as a reference.

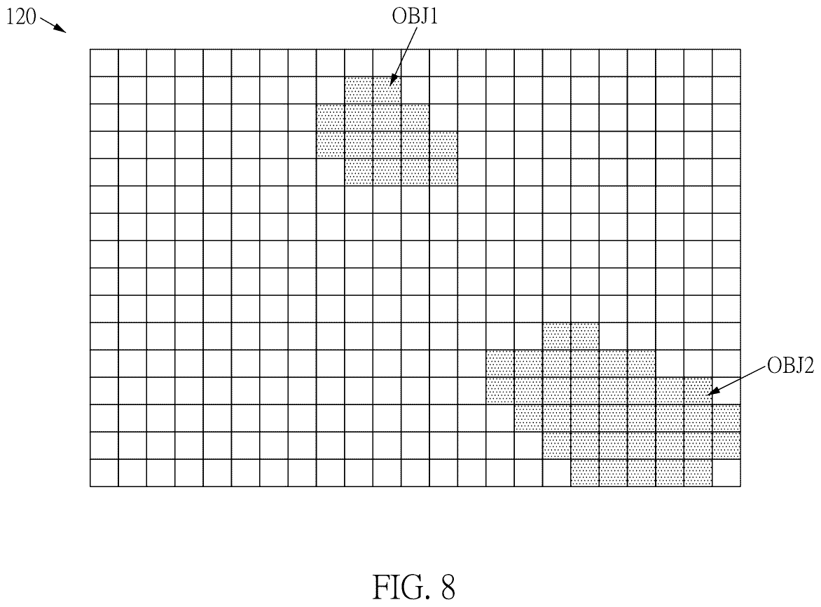

FIG. 8 is a schematic view of the sensing region with a detected finger object and a detected non-finger object according to the another one embodiment of the present disclosure. Referring to FIG. 8, when a user place his/her right hand on the touchpad 12 and swipes the index finger, the index finger and the palm of the right hand are detected in the sensing region 120 of the touchpad 12 at the same time, thus the first touch object OBJ1 and the second touch object OBJ2 can be simultaneously detected by the touchpad 12. Moreover, the second touch object OBJ2 can be determined as the non-finger object by using one or more of the steps mentioned in FIG. 4, and repeated descriptions are omitted hereinafter.

In more detail, when a time difference between a point in time at which the first touch object OBJ1 appears and a point in time at which the second object OBJ2 (has been detected as the palm object) appears in the sensing region 120 is less a predetermined period of time (e.g., 0.5 ms), the controller 10 can be configured to determine that the first touch object OBJ1 and the second touch object OBJ2 appear in the sensing region 120 simultaneously.

In response to determining that the first touch object and the second touch object are the finger object and the non-finger object simultaneously appearing in the sensing region 120 in step S20, the method proceeds to step S21: reporting first touch information to the operation system indicating that the first touch object contacts the sensing region and not reporting to the operation system that the second touch object contacts the sensing region.

In step S21, when the first touch information corresponding to the first touch object OBJ is reported to the operation system, second touch information indicating that the second touch object OBJ2 (palm object) contacts the sensing region is not reported to the operation system. That is, the controller 10 can block the presence of the non-finger object when the finger object and the non-finger object simultaneously appear in the sensing region for first time.

In some embodiments, the step S21 of not reporting to the operation system that the second touch object contacts the sensing region can be performed by reporting the second touch information to the operation system indicating that the second touch object OBJ2 leaves the sensing region 120 if the second touch object OBJ was reported as contacting the sensing region 120 before reporting the first touch information.

In response to determining that the sliding first touch object OBJ1 and the second touch object OBJ2 (has been detected as the palm object) are continuously detected in the sensing region for a predetermined period of time (e.g., 3 seconds) after a first point in time at which the first touch information corresponding to the sliding first touch object OBJ1 is reported, or the first touch object OBJ1 is detected to leave the sensing region 120, the method can further proceed to step S22: reporting fourth touch information to the operation system indicating that the second touch object contacts the sensing region.

For example, after the first touch information corresponding to the sliding first touch object OBJ is reported for 3 seconds, the controller 10 can cancel the blocking operation against the second touch object OBJ2 and report fourth touch information to the operation system indicating that the second touch object OBJ2 contacts the sensing region 120.

Therefore, when the user wants to manipulate a cursor and places his/her hand with a finger swiping on the touchpad 12, if the user's palm accidentally touches the sensing region 120, the touchpad device 1 can exclude accidental touch issue and immediately respond the manipulation of the user to the cursor without any delay.

In response to determining that the first touch object and the second touch object are not the sliding object and the palm object simultaneously appearing in the sensing region 120 in step S20, the method proceeds to step S23: performing a normal touch detection. In step S23, the normal touch detection can be performed by reporting touch information of the first touch object OBJ1 and the second touch object OBJ2 to the operation system 20.

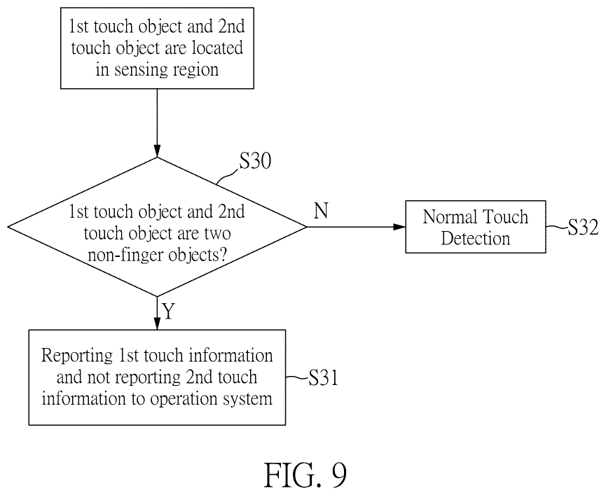

FIG. 9 is a flowchart of a method for generating touchpad information according to yet another one embodiment of the present disclosure. The present disclosure further provides another method for generating touchpad information, which includes the following steps performed by the controller 10:

Step S30: in response to detecting a first touch object and a second touch object are located in a sensing region of the touchpad, determining whether the first touch object and the second touch object are the first palm object and the second palm object.

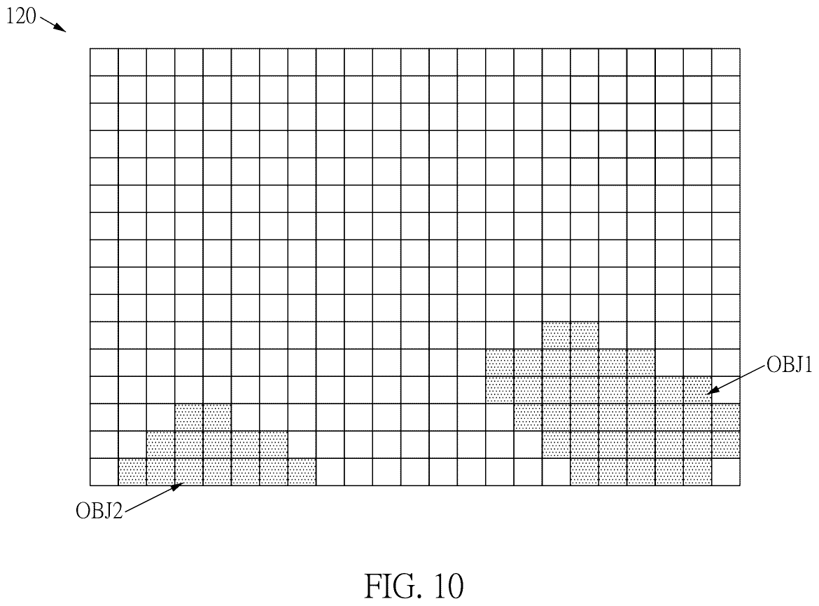

FIG. 10 is a schematic view of the sensing region with two detected non-finger objects according to the another one embodiment of the present disclosure. Referring to FIG. 10, when a user places his/her right hand on the touchpad 12, the user may accidentally place the left hand's palm on the touch pad 12 while using a keyboard. Therefore, the palm of the right hand and the palm of the left hand are detected in the sensing region 120 of the touchpad 12, thus the first touch object OBJ1 and the second touch object OBJ2 can be simultaneously or at different timing detected by the touchpad 12. Furthermore, whether or not the first touch object OBJ1 and the second touch object OBJ2 are non-finger (e.g., palm) objects can be determined by using one or more of the steps mentioned in FIG. 4, and repeated descriptions are omitted hereinafter.

In response to detecting that the first touch object and the second touch object are non-finger objects in step S30, the method proceeds to step S31: reporting first touch information to an operation system that the first touch object OBJ1 contacts the sensing region 120 and not reporting to the operation system that the second object OBJ2 contacts the sensing region 120.

For example, if two non-finger objects are simultaneously detected in the sensing region 120, the controller 10 can be configured to block a presence of one of the non-finger object by not reporting touch information thereof to the operation system.

Generally, the controller 10 can randomly block the presence of any one of the two non-finger objects, but in certain cases, if the controller 10 detects that the first touch object OBJ1 contacts the sensing region 120 before the second touch object OBJ2 contacts the sensing region 120, the controller 10 can be configured to specifically not report to the operation system that the second object OBJ2 contacts the sensing region 120.

In this case, the controller 10 can be configured to generate touchpad information that includes the first touch information, the second touch information and the third touch information.

The first touch information and the second touch information reported to the operating system can block the presence of one of the non-finger objects when two non-finger objects appear and are detected by the touchpad 12 simultaneously. Similarly, the step S31 of not reporting to the operation system that the second touch object OBJ2 contacts the sensing region 120 can be performed by reporting the second touch information to the operation system indicating that the second touch object OBJ2 leaves the sensing region 120 if the second touch object OBJ was reported as contacting the sensing region 120 before reporting the first touch information.

In step S31, the first touch information and the second touch information are shown in the following table III:

TABLE III

| Touch information | Touch Object | Content |
|---|---|---|
| 1st | 1st | Position: X1/type: palm/left: no |
| 2nd | 2nd | Position: X2/type: palm/left: Yes |

Therefore, when the user wants to move the cursor and places his/her finger swiping on the touchpad 12, if the user's both palms accidentally touches the sensing region 120, the touchpad device 1 can exclude accidental touch issues and immediately respond the manipulation of the user to the cursor without any delay or falsely triggering other functions.

Moreover, in response to determining that the first touch object and the second touch object are not two non-finger objects in step S30, the method proceeds to step S32 to perform the normal touch detection without purposely reporting any of the first touch object OBJ1 and the second touch object OBJ2 leaving the sensing region 120.

[Beneficial Effects of the Embodiments]

In conclusion, in the touchpad device and the method for generating touchpad information provided by the present disclosure, since the touch information reported to the operating system can block the presence of the palm objects when the finger object and the palm objects are detected simultaneously by the touchpad, the touchpad device can exclude accidental touch issue and immediately respond the manipulation of the user without any delay or falsely triggering other functions.

Furthermore, a variety of manners are provided for the touchpad device and the method for generating touchpad information provided by the present disclosure to determine whether or not the touch object is the palm object, such that the controller can report the corresponding touch information to precisely block the presence of the palm object(s) in specific conditions.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A method for generating touchpad information, comprising:
performing, by a controller connected to a touchpad, following processes:
in response to detecting that a first touch object is located in a sensing region of the touchpad, determining whether or not a specific touch event is identified;
in response to determining that the specific touch event is identified, determining whether a second touch object is located in a first predefined region of the sensing region, and determining whether the second touch object is a predefined object;
in response to determining that the second touch object is located in the first predefined region and the second touch object is the predefined object, reporting first touch information and second touch information to an operation system,
wherein the first touch information is used as masking information to simulate that the second touch object leaves the sensing region, and the second touch information indicates that the specific touch event occurs.

2. The method according to claim 1, wherein the specific touch event is a click event, and in response to determining that one of a single-tap event, a physical-click event, a tap-to-click event, and a corner-tap event occurs, the controller is configured to determine that the specific touch event is identified.

3. The method according to claim 1, wherein the predefined touch object is a non-finger object, and the first predefined region includes a first sub-region located at a lower right corner of the sensing region and a second sub-region located at a lower left corner of the sensing region.

4. The method according to claim 1, wherein, in response to determining that the second touch object is detected but not in the first predefined region or the second touch object is not the predefined object, the controller is configured to report the second touch information and third touch information to the operating system, wherein the third touch information indicates that the second touch object contacts the sensing region.

5. A method for generating touchpad information, comprising:
performing, by a controller connected to a touchpad, following processes:
in response to detecting a first touch object and a second touch object are located in a sensing region of the touchpad, determining whether the first touch object and the second touch object are respectively a finger object and a non-finger object simultaneously appearing in the sensing region;
in response to determining that the first touch object and the second touch object are the finger object and the non-finger object simultaneously appearing in the sensing region, reporting first touch information to an operation system indicating that the first touch object contacts the sensing region and not reporting to the operation system that the second touch object contacts the sensing region.

6. The method according to claim 5, wherein the process of not reporting to the operation system that the second touch object contacts the sensing region includes reporting second touch information to the operation system indicating that the second touch object leaves the sensing region if the second touch object was reported as contacting the sensing region before reporting the first touch information.

7. The method according to claim 5, wherein, after reporting the first touch information, further reporting fourth touch information to the operation system indicating that the second touch object contacts the sensing region.

8. The method according to claim 7, wherein the fourth touch information is reported after the first touch object left the sensing region.

9. (canceled)

10. (canceled)
